(19) United States
(12) Patent Application Publication
(10) Pub. No.: US 2002/0065790 A1
(43) Pub. Date: May 30, 2002

(54) Cost estimation method, cost estimation apparatus, product manufacturing estimation method and product manufacturing estimation apparatus

(76) Inventor: Toshihiro Oouchi, Miura-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/988,136

(22) Filed: Nov. 19, 2001

(30) Foreign Application Priority Data
Nov. 20, 2000 (JP) 2000-353234

(51) Int. Cl. G06F 17/00

(52) U.S. Cl. 705/400

(57) ABSTRACT

An estimation element necessary to determine a manufacturing process is extracted. A physical unit value corresponding to the estimation element is extracted from a physical unit table that contains cost physical unit values used in each step of the manufacturing process. An estimation formula expressed at least by a four-rule calculation rule is automatically converted into a format that can be executed by a preinstalled programming rule. The physical unit value is substituted in the converted estimation formula, thereby obtaining costs required in each step.

### CROSS-REFERENCE TO RELATED APPLICATIONS

This application is based upon and claims the benefit of priority from the prior Japanese Patent Application No. 2000-353234, filed Nov. 20, 2000, the entire contents of which are incorporated by reference.

### BACKGROUND OF THE INVENTION

1. Field of the Invention

The present invention relates to a cost estimation method and apparatus for estimating costs required when manufacturing a product, and also a product-manufacturing estimation method and apparatus.

2. Description of the Related Art

The process of manufacturing a product includes various steps for executing a processing operation or an assembling operation on a work. Products are manufactured through such steps. The costs required for the manufacturing process are estimated. Further, also when processing or assembling works, required costs are estimated.

The cost estimation is executed using an estimation formula. In the estimation formula, the values of estimation elements and the physical unit values of costs are expressed by four fundamental arithmetic operators.

The estimation elements are items required to determine the manufacturing process. The estimation elements are extracted while observing a two-dimensional drawing that illustrates a product. Specifically, the estimation elements are, for example, outside dimensions (length, width), an angled shape, a hole shape, a plate thickness and a material, etc.

Further, in the case of sheet metal processing, determination as to punching, an angled shape, welding, coating, etc. is executed while observing a two-dimensional drawing, thereby extracting elements necessary for estimation, such as the values of and/or comments on, for example, the length through which welding is executed, the length of a leg, a material and the accuracy of polishing, etc.

The cost physical unit value indicates the physical unit value of costs to be referred to at the time of estimation calculation. The cost physical unit value is shown in a physical unit table. The physical unit table is expressed by a number n of parameters (n: 1, 2, 3, . . . ) corresponding to the types of estimation elements that determine the physical unit. For example, in the case of an angled shape, the physical unit table is expressed by three parameters—plate thickness, length and width.

Accordingly, the cost estimation is executed using an estimation formula, in which estimation element values and cost physical unit values are substituted.

The calculation process for the cost estimation is formed as a source program dedicated to the cost estimation. The source program is prestored in a storage device, and executed to estimate costs.

However, since the calculation process for cost estimation is installed as a source program, it is necessary to change the source program whenever the estimation formula is changed.

The process of manufacturing a product is often reviewed and changed. Also, when processing or assembling works, the processing or assembling method is often reviewed. Accordingly, the estimation formula is rewritten each time the manufacturing process is changed.

However, it is difficult to change the source program itself, in which the calculation process for cost estimation is specified.

### BRIEF SUMMARY OF THE INVENTION

It is an object of the present invention to provide a cost estimation method and apparatus, and a product manufacturing estimation method and apparatus, which can estimate required costs independent of changes in estimation standards such as estimation elements, a physical unit table and estimation formulas, etc.

According to a major aspect of the invention, there is provided a cost-estimation method comprising: extracting an estimation element necessary to determine a manufacturing process; extracting a cost physical unit value, which corresponds to the estimation element, from a physical unit table showing cost physical unit values used in each step of the manufacturing process; automatically converting an estimation formula, expressed at least by a four-rule calculation rule, into a format which can be executed by a preinstalled programming rule; and substituting the physical unit value in the estimation formula converted into the format, thereby obtaining costs of the each step.

According to another major aspect of the invention, there is provided a cost-estimation apparatus comprising: an estimation element database which stores an estimation element necessary to determine a manufacturing process from a three-dimensional product CAD model; an estimation reference database which stores a cost physical unit value used in each step of the manufacturing process; an estimation-element-extracting section which extracts the estimation element from the estimation element database; a source-program-creating section configured to create a source program, the source program automatically converting an estimation formula, expressed at least by a four-rule calculation rule, into a format which can be executed by a preinstalled programming rule; and a cost-estimating section configured to obtain costs of the each step by substituting the physical unit value, extracted from a physical unit table, in the estimation formula converted by the source-program-creating section.

According to a further major aspect of the invention, there is provided a product-manufacture-estimation method comprising: extracting an estimation element necessary to determine manufacturing steps; setting the steps of manufacturing a product on the basis of the estimation element; estimating costs required for each step; multiplying the estimated costs by a process rate, and adding a material cost to the multiplication result, thereby calculating a whole cost; estimating and analyzing a rate-determining factor on the basis of the estimated costs and whole cost; and executing a cost simulation by varying the processing step, analyzing a degree of influence upon the whole cost, and assisting the designing of the manufacturing steps.

According to yet another major aspect of the invention, there is provided a product-manufacture-estimation apparatus comprising: an estimation element database which stores an estimation element necessary to determine a manufacturing process from a three-dimensional product CAD model; an estimation reference database which stores a cost physical unit value used in each step of the manufacturing process, and an estimation formula expressed at least by a four-rule calculation rule; a process setup reference database which prestores reference data for process setup; a process-rate/material-cost database which prestores a material unit price, a purchase unit price and a process rate; an estimation-element-extracting section which extracts the estimation element from the estimation element database; a process setup section which searches the process setup reference database on the basis of the estimation element extracted by the estimation-element-extracting section, thereby setting the manufacturing process; a source-program-creating section configured to create a source program, the source program automatically converting the estimation formula, stored in the estimation element reference database, into a format which can be executed by a preinstalled programming rule; a cost-estimating section configured to obtain costs of the each step set in the process setup section by substituting the physical unit value extracted from a physical unit table, in the estimation formula converted by the source-program-creating section; a cost estimating section which multiplies the costs estimated by the cost-estimating section, by the process rate stored in the process-rate/material-cost database, and adds a material cost, based on the material unit price, to the multiplication result, thereby calculating a whole cost; a cost analyzing section which estimates and analyzes a rate-determining factor on the basis of the costs estimated by the cost-estimating section, and the whole cost calculated by the cost estimating section; and a cost simulation section which executes a cost simulation by varying the processing step, analyzing a degree of influence upon the whole cost, and assisting the designing of the manufacturing process.

Thus, the present invention can estimate required costs independent of changes in estimation standards such as the estimation element, physical unit table and estimation formula, etc.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view illustrating the entire configuration of a product manufacturing estimation apparatus, to which a cost estimation apparatus according to an embodiment of the invention is applied;

FIG. 2 is a schematic view illustrating estimation elements used in the apparatus;

FIG. 3 is a schematic view illustrating a process setup reference database used in the apparatus;

FIG. 4 is a schematic view illustrating an estimation reference database used in the apparatus;

FIG. 5 is a schematic view illustrating a physical unit table stored in the estimation reference database used in the apparatus;

FIG. 6 is a schematic view illustrating a process-rate/materials-cost database used in the apparatus;

FIG. 7 is a flowchart for estimation used in the apparatus;

FIG. 8 is a view showing a main component and a sub-component for sheet metal to be designed;

FIG. 9 is a component configuration table created by the apparatus;

FIG. 10 is a view illustrating an example in which an estimation formula is converted into an executable formula by the apparatus;

FIG. 11 is a graph illustrating the costs of components manufactured by the apparatus;

FIG. 12 is a graph illustrating the costs of components manufactured by the apparatus; and

FIG. 13 is a view illustrating a cost simulation example.

### DETAILED DESCRIPTION OF THE INVENTION

An embodiment of the invention will be described with reference to the drawings.

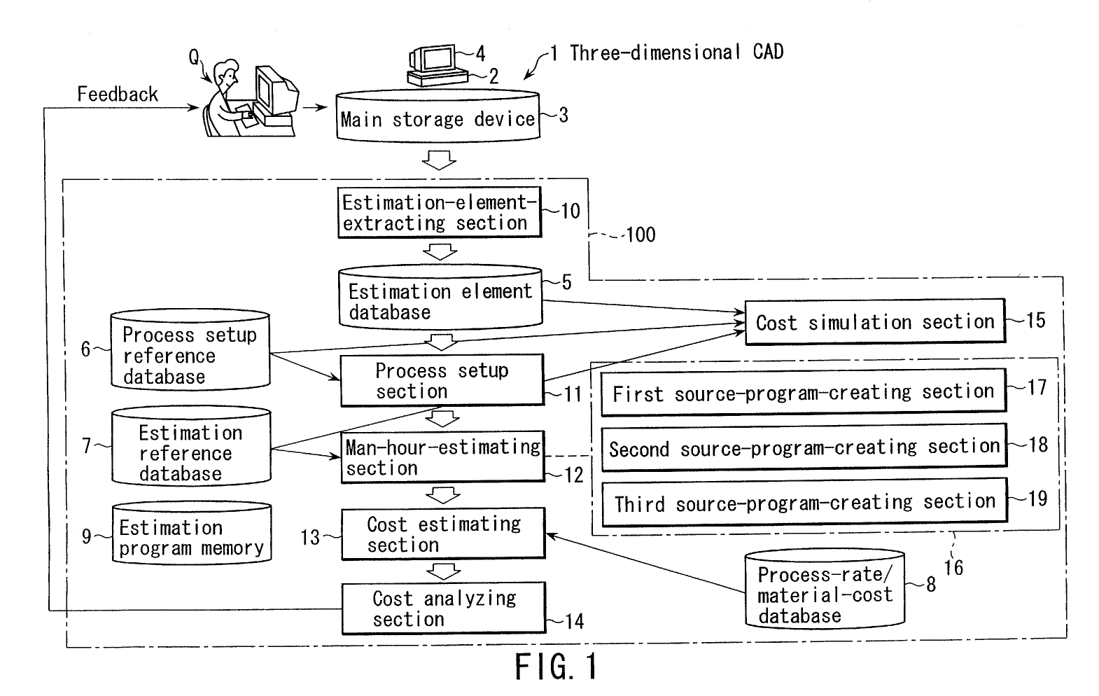

FIG. 1 a view illustrating the entire configuration of a product manufacturing estimation apparatus. Three-dimensional CAD 1 includes an arithmetic process section 2, a main storage 3 and a CAD display section 4. The main storage 3 stores design data for three-dimensional products. This data is, for example, Pro/ENGINEER data. The CAD display section 4 is, for example, a CRT display.

The three-dimensional CAD 1 executes a designing process in accordance with a dialogue with an operator Q, thereby modeling a three-dimensional CAD model for a product. The three-dimensional CAD 1 displays, as well as the dialogue with the operator Q, a three-dimensional model, which is now being modeled, on the CAD display section 4.

The three-dimensional CAD 1 creates three-dimensional CAD model data by modeling the three-dimensional CAD model. Attribute information in the three-dimensional CAD model is attached to the three-dimensional CAD data.

In the case of, for example, processing sheet metal, the attribute information indicates, a circular hole, a slit or a tap hole, etc. For example, a three-dimensional CAD model displayed on the CAD display section 4 contains figure information concerning the shape of a hole. The figure information includes attribute information such as a circular hole, a slit or a tap hole.

The three-dimensional CAD 1 is connected to a product manufacturing estimation apparatus 100. The product manufacturing estimation apparatus 100 comprises an estimation element database 5, a process setup reference database 6, an estimation reference database 7, a process-rate/material-cost database 8 and an estimation program memory 9.

The three-dimensional CAD 1 reads and writes data from and to the estimation element database 5, the process setup reference database 6, the estimation reference database 7 and the process-rate/material-cost database 8.

The three-dimensional CAD 1 executes a product manufacturing estimation program stored in the estimation program memory 9. The estimation apparatus 100 comprises an estimation-element-extracting section 10, a process designing section 11, a cost-estimating section 12, a cost estimating section 13, a cost analyzing section 14 and a cost simulation section 15.

The estimation element database 5 stores estimation elements (which are also called estimation parameters) necessary for estimation. Each estimation element is extracted by the estimation-element-extracting section 10 from the main storage 3 of the three-dimensional CAD 1.

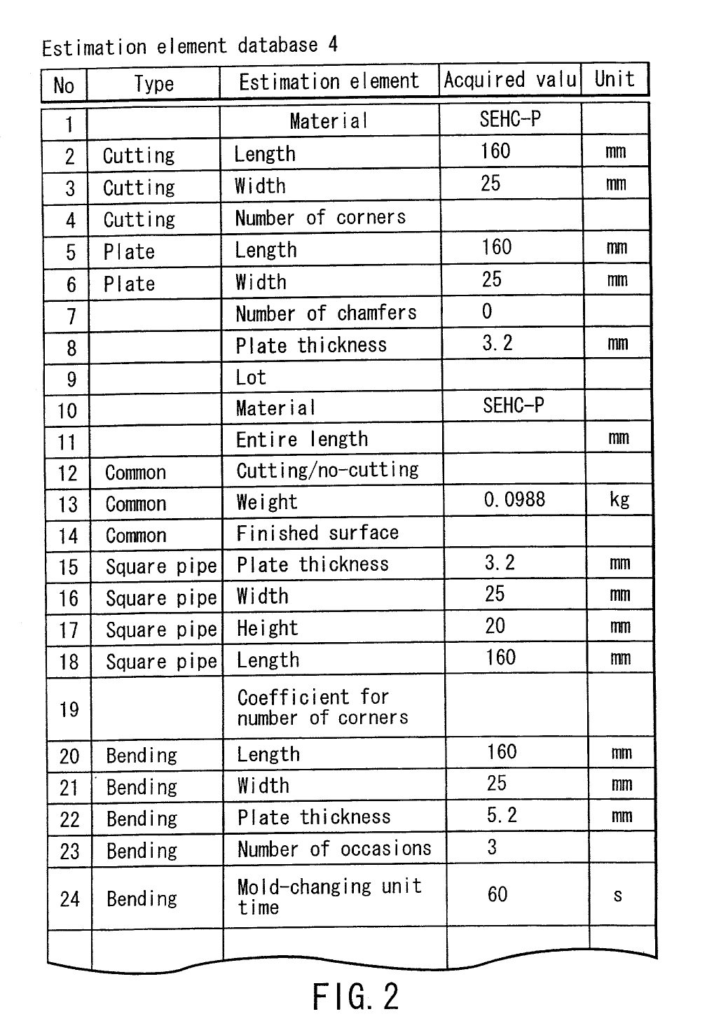

FIG. 2 is a schematic view illustrating an example of the estimation element database 4. The estimation element database 5 stores data relating to four items, i.e. “type”, “estimation element”, “acquired value” and “unit”. As a “type” item, “cutting” “plate” or “square pipe”, etc. is stored. As an “estimation element”, “material”, “length” and “width”, etc. is stored. As an “acquired value”, the value of the estimation element is stored. The item “unit” indicates the unit of the acquired value.

“Common” stored as a “type” item indicates a standard matter commonly used for all types, irrespective of the type of, for example, “cutting”, “plate” or “square pipe”, etc.

Each blank column for “acquired value” indicates an estimation element that could not be acquired by the three-dimensional CAD 1. In each blank column for “acquired value”, the operator Q stores an estimation element value by a manual operation.

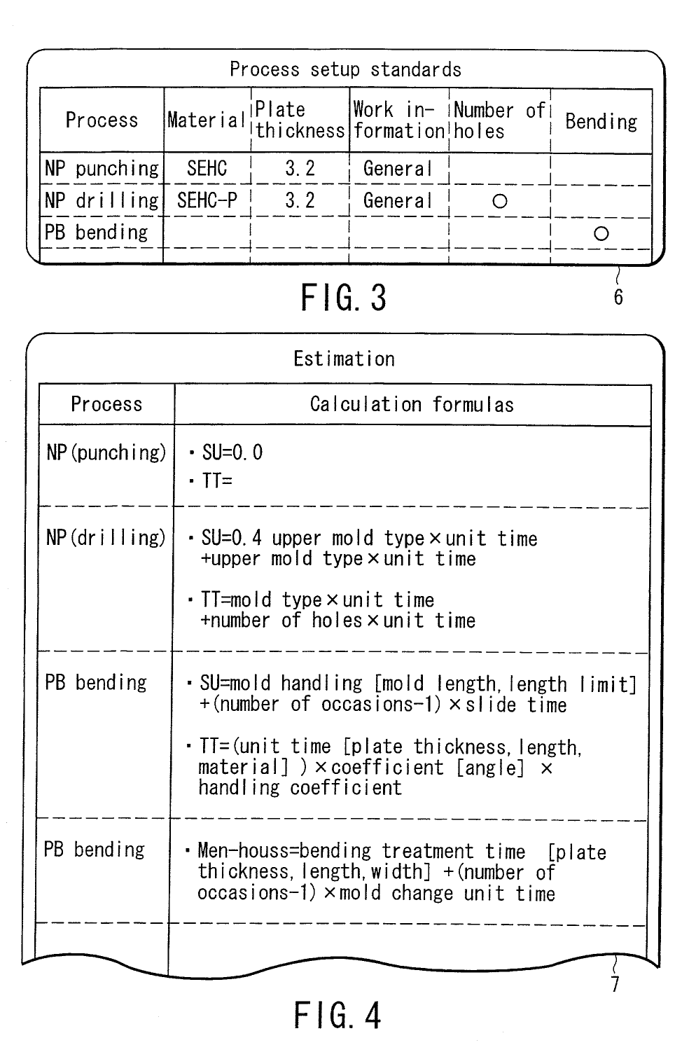

The process setup reference database 6 prestores reference data for process setup. FIG. 3 is a schematic view illustrating an example of the process setup reference database 6. As process setup reference data, data, such as “material”, “plate thickness”, “process information”, “the number of holes” and data concerning “bending”, is stored for each process. As a process, for example, “NP punching”, “NP drilling” or “PB bending” is stored. In the section of, for example, the “NP punching” process, material “SEHC”, plate thickness “3.2” and process information “general” are stored.

The estimation reference database 7 stores estimation formulas. FIG. 4 is a schematic view illustrating an example of the estimation reference database 7. The estimation reference database 7 stores respective estimation formulas for, for example, three types of processing steps, i.e. “NP (punching)”, “NP (drilling)” and “PB (bending)”.

For example, a PB (bending) estimation formula is:

Cost=bending time period[plate thickness, length, width]+(the number of times−1)×mold-changing unit time

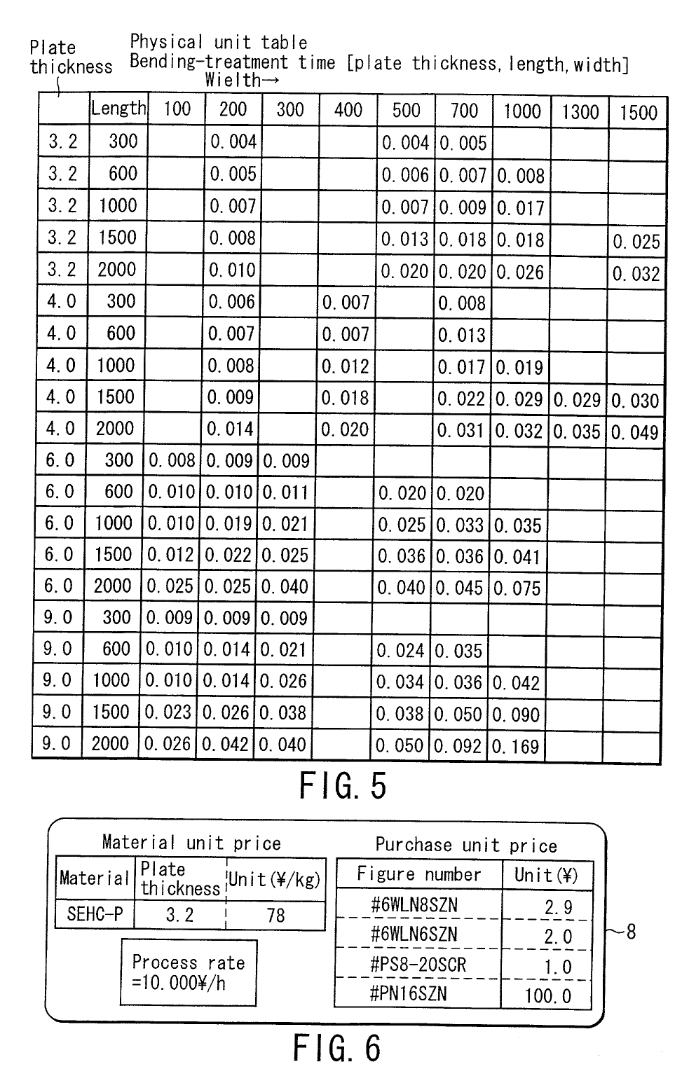

Further, the estimation reference database 7 stores a physical unit table as shown in FIG. 5. The physical unit table is referred to when using each estimation formula. The physical unit table indicates, for example, bending time periods. Each bending time period is determined from the relationship between “plate thickness”, “length” and “width”. Each bending time period is expressed by [plate thickness, length, width].

The process-rate/material-cost database 8 prestores, for example, a material unit price, a purchase price and a process rate.

On the other hand, the estimation-element-extracting section 10 acquires attribute information attached to three-dimensional CAD model data stored in the main storage device 2 of the three-dimensional CAD 1. The estimation-element-extracting section 10 downloads the attribute information as text data, using an extended language in the three-dimensional CAD 1, thereby acquiring the estimation elements shown in FIG. 2.

The process setup section 11 searches the prestored process setup reference database 6 shown in FIG. 3, on the basis of estimation element values acquired by the estimation-element-extracting section 10, and on the basis of whether or not there is an estimation element value, thereby setting a product manufacturing step. This step is appropriately changed in each processing step of the product manufacturing, thereby enabling all manufacturing steps of sheet-metal working, grinding, assembling, etc.

The cost-estimating section 12 executes calculations using the estimation formulas, which are shown in FIG. 4 and stored in the estimation reference database 5, thereby estimating the costs of each product manufacturing step set by the process setup section 11.

The cost-estimating section 12 estimates costs by processing a programming rule preinstalled in the product manufacturing estimation apparatus 100.

The cost-estimating section 12 includes a program-automatic-creating section 16 configured to automatically convert each estimation formula shown in FIG. 4 into an executable format when estimating the costs of each manufacturing step.

The program-automatic-creating section 16 automatically converts each estimation formula into a format that can be executed by a programming rule prestored in the estimation program memory 9.

The program-automatic-creating section 16 includes first, second and third source-program-creating sections 17, 18 and 19. The first source-program-creating section 17 creates a first source program for extracting each estimation element from the estimation formulas shown in FIG. 4, and converting each estimation element into a format that can be executed by a preinstalled programming rule.

The second source-program-creating section 18 creates a second source program for extracting, from the estimation formulas shown in FIG. 4, estimation elements that form the physical unit table, then converting each estimation element into a format that can be executed by a corresponding preinstalled programming rule, and extracting each physical unit value from the physical unit table stored in the estimation reference database 7.

The third source-program-creating section 19 converts each estimation formula into a format that can be executed by a corresponding preinstalled programming rule, on the basis of the first and second source programs created by the first and second source-program-creating sections 17 and 18.

Moreover, the program-automatic-creating section 16 converts each estimation formula including a function, into a format that can be executed by a corresponding programming rule preinstalled in the cost-estimating section. For example, in the case where a plurality of estimation elements are included in an estimation formula, a function in the formula obtains the sum of them, using the estimation formula. The function numbers the number of estimation element names. The function numbers the number of the types of estimation element names. If a plurality of estimation elements are included, the function obtains a maximum value or a maximum value thereof.

The estimation program memory 9 stores a program for operating the process estimating section 12. This program includes the following instructions—an instruction to extract each estimation element from the estimation formulas; an instruction to create the first source program for converting each estimation element into a format that can be executed by a preinstalled programming rule; an instruction to extract, from the estimation formulas, estimation elements that form the physical unit table; an instruction to convert each estimation element into a format that can be executed by a corresponding preinstalled programming rule; an instruction to create the second source program for extracting each physical unit value from the physical unit table stored in the estimation reference database 7; and an instruction to convert each estimation formula into a format that can be executed by a corresponding preinstalled programming rule, on the basis of the first and second source programs.

The cost estimating section 13 multiplies the costs, estimated by the process estimating section 12, by the process rate stored in the process-rate/ material-cost database 8, and adds a material unit price and a purchase unit price to the resultant value, thereby estimating the whole cost.

On the basis of the costs estimated by the cost-estimating section 12 and the cost estimated by the cost estimating section 13, the cost analyzing section 14 analyzes and estimates a rate-determining factor, using a component-cost-analyzing graph, a process-cost-analyzing graph and a check list. After that, the cost analyzing section 14 indicates a factor that inhibits a cost reduction, or a design improvement factor for facilitating processing.

The cost simulation section 15 executes cost simulation by changing design elements, manufacturing methods, processing steps. The cost simulation section 15 analyzes the degrees of influence of these factors upon the cost from the cost simulation results, thereby assisting the designing of an optimal manufacturing method and step.

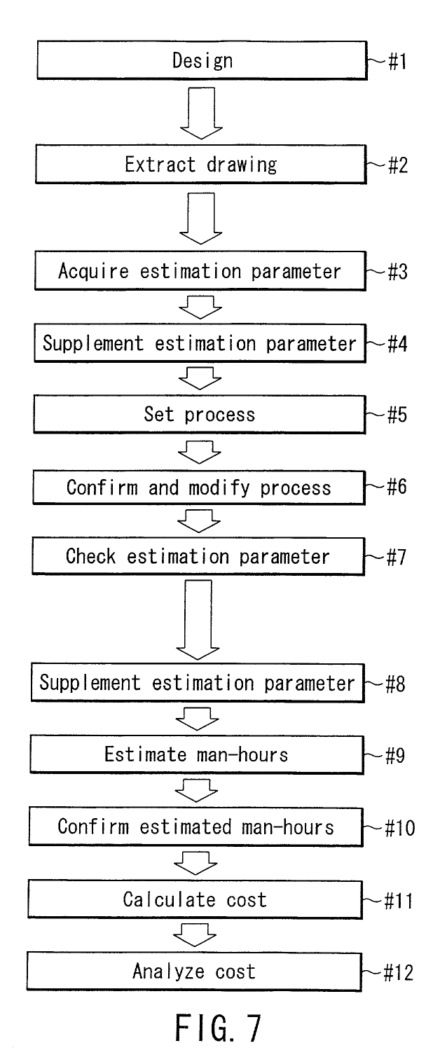

Referring now to the estimation flowchart of FIG. 7, the operation of the apparatus constructed as above will be described.

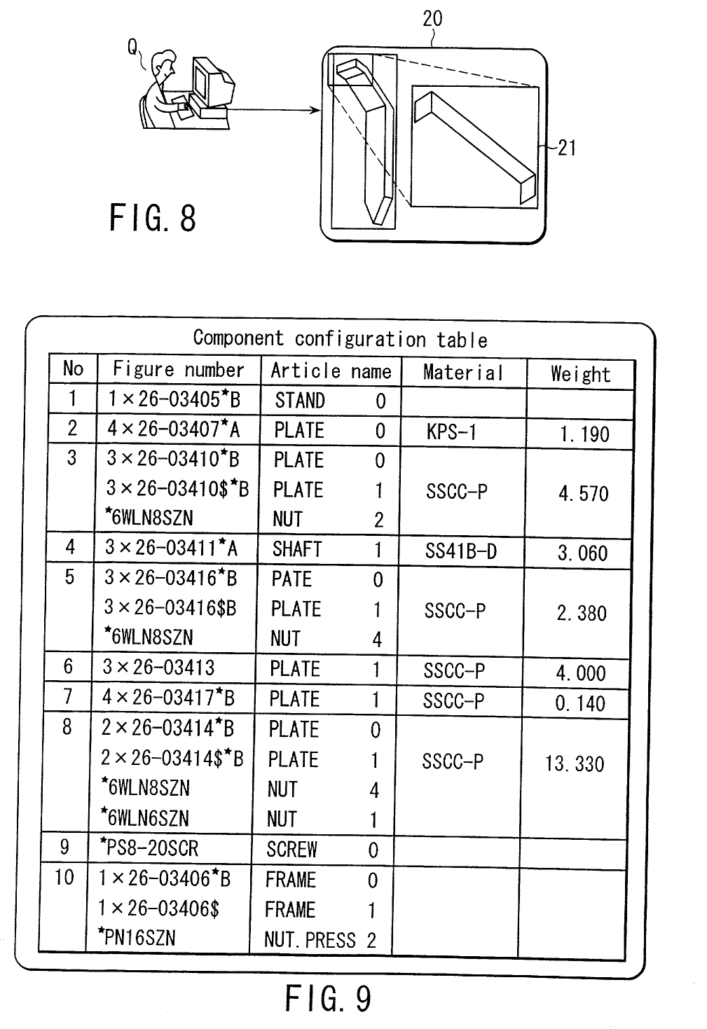

At a step #1, the three-dimensional CAD 1 executes a program dedicated to designing a three-dimensional product, thereby designing, for example, sheet metal while modeling a three-dimensional CAD model by a dialogue with the operator Q. This sheet metal is formed of a main component 20 and a sub-component 21 as shown in FIG. 8.

The three-dimensional CAD 1 displays the three-dimensional model and the dialogue with the operator Q on the CAD display section 11 such as a display.

The three-dimensional CAD 1 adds attribution information to three-dimensional CAD model data. In the case of, for example, sheet metal processing, the attribute information indicates a circular hole, a slit or a tap hole, etc. to be added to figure information indicative of the shape of a hole.

When designing sheet metal, the three-dimensional CAD 1 creates a three-dimensional CAD model of the sheet metal, and also a component configuration table as shown in FIG. 9.

The component configuration table is formed of, for example, ten types of sub-components. The component configuration table includes data items “figure number”, “component name”, “material” and “weight”.

Subsequently, at steps #2 and #3, the estimation-element-extracting section 10 acquires, when the three-dimensional CAD 1 creates the three-dimensional CAD model, the attribute information attached to the three-dimensional CAD model data, as an estimation element.

In the case of sheet metal processing, the estimation element indicates the aforementioned circular hole, slit or tap hole, etc. to be added to figure information indicative of the shape of a hole.

After that, at a step #4, the estimation-element-extracting section 10 supplements a lacking parameter in accordance with the operation of the operator Q, if an extracted estimation element is insufficient to specify a manufacturing process.

The estimation-element-extracting section 10 stores, in the element database 5, each estimation element extracted from the three-dimensional CAD 1.

Thereafter, at a step #5, the process-setup-processing section 11 searches the process setup reference database 6 shown in FIG. 3, on the basis of each estimation element value or information as to whether or not there is an estimation element, acquired by the estimation-element-extracting section 10, thereby setting a product manufacturing step.

This step is appropriately changed in each processing step of the product manufacturing, thereby enabling all manufacturing steps of sheet-metal working, grinding, assembling, etc.

Subsequently, if the set step is confirmed and an error is found, the three-dimensional CAD 1 executes, at a step #6, addition or correction of an error in a step by a dialogue with the operator.

Then, the cost-estimating section 12 checks, at a step #7, whether or not the estimation reference database 7 sufficiently acquires the estimation formulas shown in FIG. 4 and the estimation elements used in the cost physical unit table shown in FIG. 5.

If all the estimation formulas and estimation elements are not acquired, the cost-estimating section 12 issues a warning to urge their supplement.

After that, if it is determined at a step #8 that all the estimation elements are not acquired, the cost-estimating section 12 executes supplement to complete them.

At the next step #9, the cost-estimating section 18 automatically converts each estimation formula, shown in FIG. 4 and stored in the estimation reference database 7, into a format that can be executed by a preinstalled programming rule.

Specifically, the first source-program-creating section 17 extracts estimation elements from each estimation formula shown in FIG. 4, thereby creating a first source program that can execute the estimation elements using a preinstalled programming rule with reference to a standard source code S shown in FIG. 9.

The standard source code S for acquiring estimation element values comprise a program for referring to estimation elements stored in the estimation element database 5 shown in FIG. 2.

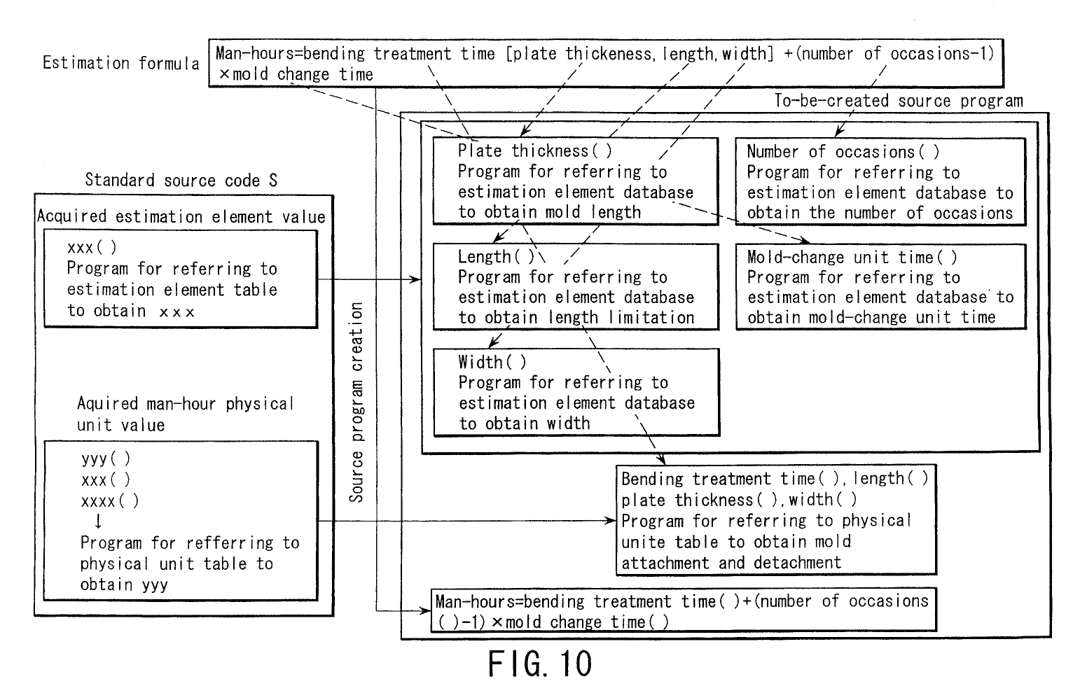

XXX included in a standard source code XXX( ) shown in FIG. 10 indicates a variable. This variable is an estimation element. The standard source code S for the acquisition of an estimation element is, for example, a program for acquiring the format XXX( ) by referring to the estimation element stored in the estimation element database 5 shown in FIG. 2.

A description will now be given of, for example, a case where the estimation formula is:

costs=bending-treatment time[plate thickness, length, width]+(the number of occasions−1)×mold-changing unit time

The first source-program-creating section 17 extracts, from the above estimation formula, estimation elements (plate thickness, length, width, the number of occasions, mold-changing unit time).

Thereafter, the first source-program-creating section 17 creates the first source program that can execute the estimation elements using the preinstalled programming rule, with reference to the estimation elements stored in the estimation element database 5 shown in FIG. 2.

For example, the first source-program-creating section 17 creates the first source program that converts the estimation elements (plate thickness, length, width, the number of occasions, mold-changing unit time), extracted from the above estimation formula, into respective formats of “plate thickness” ( ), “length” ( ), “width” ( ), “the number of occasions” ( ) and “mold-changing unit time” ( ).

Thus, as shown in FIG. 10, a program for obtaining the format of “plate thickness” ( ) by referring to (searching) the estimation element database 5, a program for obtaining the format of “length” ( ) by referring to (searching) the estimation element database 5, a program for obtaining the format of “width” ( ) by referring to (searching) the estimation element database 5, a program for obtaining the format of “the number of occasions” ( ) by referring to (searching) the estimation element database 5, and a program for obtaining the format of “mold-changing unit time” ( ) by referring to (searching) the estimation element database 5 are created.

The extraction of the estimation elements from the estimation formulas is executed, using identifiers [ ], ( ) represented by four fundamental arithmetic operators and included in the estimation formulas, or using estimation element names.

After that, the second source-program-creating section 18 adds, referring to the physical unit table shown in FIG. 5, those of the estimation elements converted by the first source-program-creating section 17, which are necessary to obtain physical unit values.

Subsequently, the second source-program-creating section 18 creates a second source program that can execute, using a preinstalled programming rule, those of the estimation elements included in one of the estimation formulas shown in FIG. 4, which are necessary to obtain the physical unit values.

The second source-program-creating section 18 creates the second source program with reference to the standard source code S necessary to acquire a cost physical unit value shown in FIG. 10. In this case, the standard source code S is formed of a program for referring to the physical unit table shown in FIG. 5 and stored in the estimation reference database 7.

“yyy”, “xxx” and “xxxx” included in yyy( ), xxx ( ) and xxxx ( ) of the standard source code S shown in FIG. 10 indicate variables. These variables are estimation elements. The standard source code S for acquiring the cost physical unit value is a program for acquiring, for example, the format yyy ( ) by referring to the physical unit table.

For example, the second source-program-creating section 18 creates a source program for converting the bending-treatment time [plate thickness, length, width] into formats of “bending-treatment time” (), “plate thickness” ( ), “length” ( ) and “width” ( )

Then, the second source-program-creating section 18 creates a source program for extracting the physical unit value of “bending-treatment time” ( ) from the physical unit table shown in FIG. 5.

The physical unit table comprises “plate thickness” ( ), “length” ( ) and “width” ( ) Accordingly, the second source-program-creating section 18 creates a source program for extracting the physical unit value of “bending-treatment time” ( ) corresponding to “plate thickness” ( ), “length” ( ) and “width” ( ).

In this case, the second source-program-creating section 18 creates a source program for the bending-treatment time, calling a source program for acquiring the estimation elements such as plate thickness, length and width.

Thereafter, the third source-program-creating section 19 executes the first and second source programs created by the first and second source-program-creating sections 17 and 18, respectively, thereby converting the above estimation formula into a format that can be executed by the preinstalled programming rule.

For example, as shown in FIG. 10, the aforementioned estimation formula:

{costs=bending-treatment time[plate thickness, length, width]+(the number of occasions−1)×mold-changing unit time}

is converted into the following estimation formula that can be executed by a preinstalled programming rule:

costs=bending-treatment time ( )+(the number of occasions ( )−1)×mold-changing unit time ( )

As a result, the process estimating section 12 refers to the estimation elements shown in FIG. 2 and the physical unit table shown in FIG. 5, thereby executing the estimation formula converted executable by the programming rule to estimate the required costs.

At a step #10, the cost estimating section 13 causes the operator Q to confirm the costs estimated by the cost-estimating section 12, and to change the estimation elements or the estimation reference if there is an error, thereby again estimating the required costs.

At the next step #11, the cost estimating section 13 inputs the costs estimated by the cost-estimating section 12, thereby multiplying the costs by a process rate stored in the process-rate/material-cost database 8 shown in FIG. 6, adding the unit price of each material and the unit price of each purchased article, and estimating the whole cost.

For example, in the case of a component of No. “7” in the component configuration table, the required cost is given by the following equations:

Process cost=process costs×process rate

=(preparatory plan+process)×process rate

=(0.16 h+0.012 h)×¥10000/h

=¥1720

Material cost=weight×unit price of material

=0.15 kg×¥78

=¥13

Purchased article=¥0

Cost=process cost+material cost+purchased article price

=¥1720+¥13+¥0

=¥1733

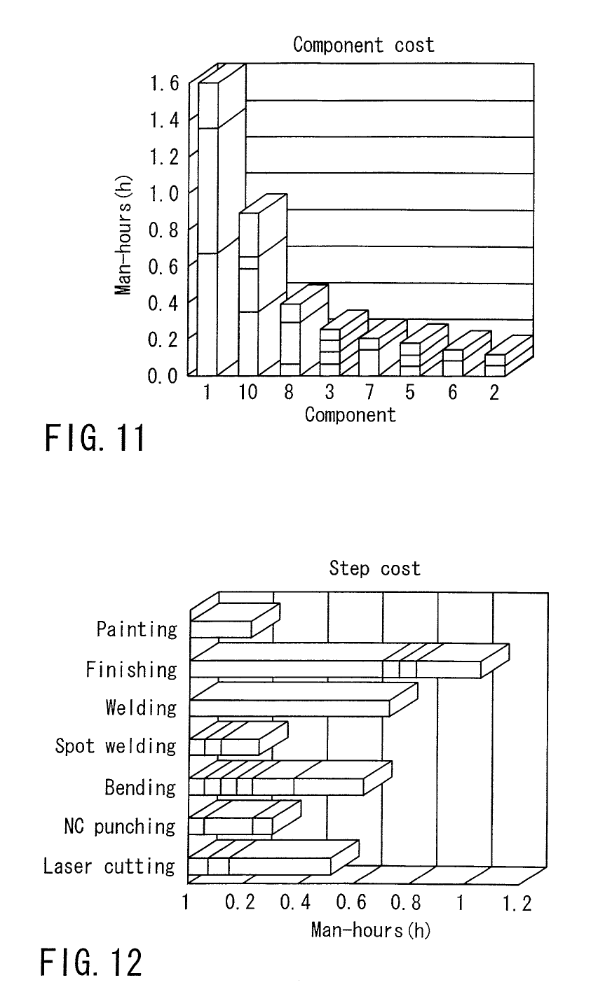

Thereafter, at a step #12, the cost analyzing section 14 creates a component-cost-analyzing graph as shown in FIG. 11, a process-cost-analyzing graph as shown in FIG. 12, and a check list, on the basis of the costs estimated by the cost-estimating section 12 and the cost estimated by the cost estimating section 13.

The operator Q analyzes and estimates a rate-determining factor, using the component-cost-analyzing graph, the process-cost-analyzing graph and the check list. The operator Q can indicate a factor that inhibits a cost reduction, or a design improvement factor for facilitating processing.

Thus, the cost analyzing section 20 provides the operator Q of the three-dimensional CAD 1 for creating a three-dimensional CAD product model, with, for example, a factor that inhibits a cost reduction, or a design improvement factor for facilitating processing, the factors serving as feedback information.

At the next step #13, on the basis of the cost/cost estimation results and the cost analysis results, design review is executed in the design section and the manufacturing section in order to reduce the cost or facilitate the process, whereby the result of design review are promptly fed back to the design elements.

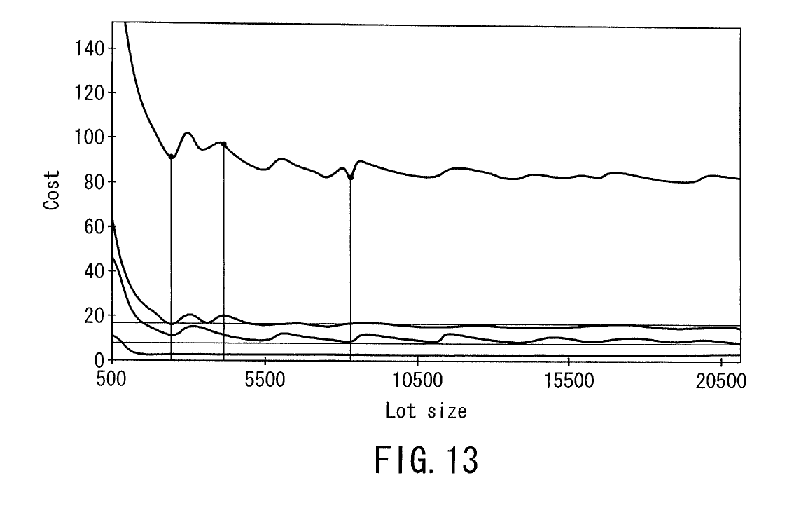

After that, the cost simulation section 15 executes a cost simulation in which the design elements, the manufacturing method and/or process steps are varied as shown in FIG. 13, thereby analyzing the degrees of influence of these factors upon the cost, and assisting the designing of an optimal manufacturing method or step.

For example, FIG. 13 illustrates an example, in which the degree of influence of “lot size” upon “cost” is simulated, using the abscissa to indicate “lot size” and the ordinate to indicate “cost”. In the case of sheet metal processing, if the abscissa is used to indicate “plate thickness”, “material” or “welding length”, etc. in place of the lot size, it can be analyzed which one of the design elements, such as “plate thickness”, “material” and “the length of welding”, etc., most influences the cost.

As described above, in the embodiment, estimation elements necessary to determine a manufacturing process are extracted; a physical unit value corresponding to each estimation element is extracted from the physical unit table that illustrates cost physical unit values in each step of the manufacturing process; each estimation formula expressed at least by the four-rule calculation rule is automatically converted into a format that can be executed by a preinstalled programming rule; and the physical unit values are substituted in the converted estimation formula to thereby obtain the costs of each step.

Thus, the product manufacturing process, working, assemblage, etc. are often reviewed and changed, thereby often reviewing and changing estimation elements, cost physical units, estimation formulas.

Changes in estimation elements, cost physical units, estimation formulas do not require changes in a programming rule preinstalled in the estimation apparatus 100 for product manufacturing. Thus, the programming rule of the product-manufacturing estimation apparatus 100 does not depend upon the estimation elements, which means that the required costs can be estimated only by changing the estimation standards.

Accordingly, the embodiment can estimate the required costs irrespective of changes in the estimation standards such as estimation elements, physical units and estimation formulas, etc.

Further, in the embodiment, estimation elements necessary to determine a manufacturing process are extracted; each product-manufacturing step is set on the basis of the estimation elements; the required costs in each step are estimated; the estimated costs are multiplied by a process rate; the required cost is calculated by adding a material cost to the result; a rate-determining factor is analyzed and estimated on the basis of the estimated costs and cost; the process step is varied to execute a cost simulation; and the influence upon the cost is analyzed, thereby assisting the manufacturing-process design.

As a result, the problems of the conventional estimation method concerning the estimation period and accuracy can be solved, whereby a delay in answering the design section a required cost can be avoided, or redesigning due to unaccomplishment of a target cost can be avoided.

Moreover, the cost analyzing section 14 can provide the three-dimensional CAD 1 for creating a three-dimensional CAD product model, with a factor that inhibits a cost reduction, or a design improvement factor for facilitating processing, the factors serving as feedback information. As a result, a cost rate-determining factor can be indicated, or the designing of an optimal manufacturing method or working step can be assisted by a cost simulation.

Therefore, in an early stage of product development, the designer themselves can estimate the cost in a short time with high accuracy, thereby significantly reducing the period required for producing a new product.

The above-described embodiment includes inventions in various stages, and various inventions can be extracted by appropriately combining disclosed configuration elements. For example, even if some of the configuration elements employed in the embodiment are deleted, the configuration without the deleted elements can be extracted as an invention, if the problem described in the section concerning a problem the invention to solve can be solved, and the advantage described in the section concerning an advantage of the invention can be obtained.

The method employed in the embodiment can be written, as a computer-executable program, to a storage medium such as a magnetic disk, an optical disk, a photomagnetic disk or a semiconductor memory, etc., and be used in various apparatuses. The computer that realizes the present invention reads a program stored in the storage medium, and operates under the control of the program, thereby executing the above-described process.

The present invention is not limited to a particular product or process, but is applicable in all manufacturing processes such as working or assemblage, etc.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A cost-estimation method comprising:
extracting an estimation element necessary to determine a manufacturing process;
extracting a cost physical unit value, which corresponds to the estimation element, from a physical unit table showing cost physical unit values used in each step of the manufacturing process;
automatically converting an estimation formula, expressed at least by a four-rule calculation rule, into a format which can be executed by a preinstalled programming rule; and
substituting the physical unit value in the estimation formula converted into the format, thereby obtaining costs of said each step.

2. The cost estimation method according to claim 1, wherein the step of executing automatic conversion includes:
creating a first source program configured to extract the estimation element from the estimation formula, and to convert the estimation element into a format which can be executed by the preinstalled programming rule;
creating a second source program configured to extract, from the estimation formula, the estimation element included in the physical unit table, to convert the estimation element into the format which can be executed by the preinstalled programming rule, and to extract the physical unit value from the physical unit table;
converting the estimation formula into the format which can be executed by the preinstalled programming rule, on the basis of the first and second source programs.

3. The cost estimation method according to claim 1, wherein in the step of executing automatic conversion, the estimation element is extracted from the estimation formula by determining an identifier and a name of the estimation element in the estimation formula, thereby converting the estimation element into the format which can be executed by the preinstalled programming rule.

4. The cost estimation method according to claim 1, wherein the estimation formula contains a function.

5. A cost-estimation apparatus comprising:
an estimation element database which stores an estimation element necessary to determine a manufacturing process from a three-dimensional product CAD model;
an estimation reference database which stores a cost physical unit value used in each step of the manufacturing process;
an estimation-element-extracting section which extracts the estimation element from the estimation element database;
a source-program-creating section configured to create a source program, the source program automatically converting an estimation formula, expressed at least by a four-rule calculation rule, into a format which can be executed by a preinstalled programming rule; and
a cost-estimating section configured to obtain costs of said each step by substituting the physical unit value, extracted from a physical unit table, in the estimation formula converted by the source-program-creating section.

6. The cost estimation apparatus according to claim 5, wherein the estimation formula contains a function, and the source-program-creating section converts the estimation formula into the format which can be executed by the preinstalled programming rule.

7. The cost estimation apparatus according to claim 5, wherein the source-program-creating section includes:
a first source-program-creating section which creates a first source program configured to extract the estimation element from the estimation formula, and convert the estimation element into a format which can be executed by the preinstalled programming rule;
a second source-program-creating section which creates a second source program configured to extract, from the estimation formula, the estimation element included in the physical unit table, to convert the estimation element into the format which can be executed by the preinstalled programming rule, and to extract the physical unit value from the physical unit table; and
a third source-program-creating section which converts, on the basis of the first and second source programs created by the first and second source-program-creating sections, the estimation formula into the format which can be executed by the preinstalled programming rule.

8. The cost estimation apparatus according to claim 5, wherein the source-program-creating section extracts the estimation element is extracted from the estimation formula on the basis of an identifier and a name of the estimation element in the estimation formula.

9. A product-manufacture-estimation method comprising:
extracting an estimation element necessary to determine manufacturing steps;
setting the steps of manufacturing a product on the basis of the estimation element;
estimating costs required for each step;
multiplying the estimated costs by a process rate, and adding a material cost to the multiplication result, thereby calculating a whole cost;
estimating and analyzing a rate-determining factor on the basis of the estimated costs and whole cost; and
executing a cost simulation by varying the processing step, analyzing a degree of influence upon the whole cost, and assisting the designing of the manufacturing steps.

10. The cost estimation method according to claim 9, wherein the step of estimating the costs includes:
creating a first source program configured to extract the estimation element from the estimation formula, and to convert the estimation element into a format which can be executed by a preinstalled programming rule;
creating a second source program configured to extract, from the estimation formula, the estimation element included in a physical unit table, to convert the estimation element into the format which can be executed by the preinstalled programming rule, and to extract the physical unit value from the physical unit table;
converting the estimation formula into the format which can be executed by the preinstalled programming rule, on the basis of the first and second source programs.

11. A product-manufacture-estimation apparatus comprising:
an estimation element database which stores an estimation element necessary to determine a manufacturing process from a three-dimensional product CAD model;
an estimation reference database which stores a cost physical unit value used in each step of the manufacturing process, and an estimation formula expressed at least by a four-rule calculation rule;
a process setup reference database which prestores reference data for process setup;
a process-rate/material-cost database which prestores a material unit price, a purchase unit price and a process rate;
an estimation-element-extracting section which extracts the estimation element from the estimation element database;
a process setup section which searches the process setup reference database on the basis of the estimation element extracted by the estimation-element-extracting section, thereby setting the manufacturing process;
a source-program-creating section configured to create a source program, the source program automatically converting the estimation formula, stored in the estimation element reference database, into a format which can be executed by a preinstalled programming rule;
a cost-estimating section configured to obtain costs of said each step set in the process setup section by substituting the physical unit value extracted from a physical unit table, in the estimation formula converted by the source-program-creating section;
a cost estimating section which multiplies the costs estimated by the cost-estimating section, by the process rate stored in the process-rate/material-cost database, and adds a material cost, based on the material unit price, to the multiplication result, thereby calculating a whole cost;
a cost analyzing section which estimates and analyzes a rate-determining factor on the basis of the costs estimated by the cost-estimating section, and the whole cost calculated by the cost estimating section; and
a cost simulation section which executes a cost simulation by varying the processing step, analyzing a degree of influence upon the whole cost, and assisting the designing of the manufacturing process.

12. The product-manufacturing estimation apparatus according to claim 11, wherein the source-program-creating section includes:
a first source-program-creating section which creates a first source program configured to extract the estimation element from the estimation formula, and to convert the estimation element into a format which can be executed by the preinstalled programming rule;
a second source-program-creating section which creates a second source program configured to extract, from the estimation formula, the estimation element included in the physical unit table, to convert the estimation element into the format which can be executed by the preinstalled programming rule, and to extract the physical unit value from the physical unit table; and
a third source-program-creating section which converts, on the basis of the first and second source programs created by the first and second source-program-creating sections, the estimation formula into the format which can be executed by the preinstalled programming rule.

13. The product-manufacturing estimation apparatus according to claim 11, wherein the estimation-element-extracting section supplements another estimation element in accordance with an input operation of an operator, if the estimation element extracted from the three-dimensional CAD model is insufficient to specify the manufacturing process.

14. The product-manufacturing estimation apparatus according to claim 11, further comprising a three-dimensional CAD which creates the three-dimensional CAD model, and wherein the cost analyzing section provides the three-dimensional CAD with a factor that inhibits a cost reduction, or a design improvement factor for facilitating processing, the factors serving as feedback information.
